(19) United States
(12) Patent Application Publication
(10) Pub. No.: US 2007/0174440 A1
(43) Pub. Date: Jul. 26, 2007

(54) Systems and methods for data mining and interactive presentation of same

(76) Inventors: John J. Brier JR., Pensacola, FL (US); Bin Tu, Clarksburg, MD (US)

Correspondence Address: GREENBERG TRAURIG, LLP, ONE INTERNATIONAL PLACE, 20th FL, ATTN: PATENT ADMINISTRATOR, BOSTON, MA, 02110, US

(21) Appl. No.: 11/436,250

(22) Filed: May 18, 2006

Related U.S. Application Data
(60) Provisional application No. 60/761,209, filed on Jan. 24, 2006.
(60) Provisional application No. 60/793,603, filed on Apr. 20, 2006.

(51) Int. Cl. G06F 15/173

(52) U.S. Cl. 709/223

(57) ABSTRACT

A data mining and presentation system including a first processor for obtaining data of interest to a user from one or more data sources. The first processor designed to receive one or more user specified parameters in connection with the data, and in communication with the data sources via a telecommunication network. A second processor in communication with the first processor, the second processor receiving and manipulating the data for presentation to the user in accordance with parameters specified by the user. The manipulated data being presented via a telecommunication network to one or more user platforms.

### CROSS-REFERENCE TO RELATED APPLICATIONS

This application claims priority to and benefit of Provisional Patent Application Ser. No. 60/761,209, filed on Jan. 24, 2006, and to Provisional patent Application Ser. No. 60/793,603, filed on Apr. 20, 2006, the entirety of both of which is incorporated herein by reference.

### TECHNICAL FIELD

This invention relates generally to the field of data mining in areas, such as, lottery results, sports, finance and entertainment, and the creation of a system to distribute such data through the Internet and/or wireless devices.

### BACKGROUND ART

Lottery is a global business with millions of people world-wide participating in lotteries every day. In the U.S.A. over 74% of all adults play the lottery. New technologies have given people the opportunity to play lotteries from all over the world no matter where they live. As such, people are looking, on a daily basis, for the results of the specific lotteries they have chosen to play.

Furthermore, a growing segment of media properties, including web sites, portals, cellular telephone companies, short message service (SMS) messaging companies, and other groups are looking for ways to get lottery data and present it to their customers or visitors. Furthermore a growing number of companies globally are looking for ways to advertise their products and services to the targeted audiences of consumers who are interested in the lottery.

In addition to lottery results, on a daily basis, people are also looking for results or data involving sports, finance, entertainment, and other fields.

As such, it would be desirable to provide a system where data or information can be collected and presented to those interested in such information in an interactive manner.

### SUMMARY OF THE INVENTION

The present invention provides, in an embodiment, a system for mining data or information relating to lottery results, sports, finance, entertainment and other areas, and for distributing such data globally through the Internet and wireless devices.

The present invention provides, in an embodiment, a data presentation system that includes a first server for obtaining data of interest to a user, and a second server in communication with the first processor. A processor may be included that can be designed to receive one or more user specified parameters in connection with the data. The second server can receive and manipulate the data for presentation to the user in accordance with user-specified parameters. The parameters can include type of data, format of the data, points of interest, event notification, method of data delivery, and frequency of delivery.

The present invention also provides a method of presenting data, which includes allowing a user to define a set of parameters for which data is to be presented. The method further provides for manipulation of the data for presentation to the user in accordance with the parameters.

The present invention further provides, in an embodiment, a data presentation system that includes a first server for obtaining data of interest to a user, and a second server in communication with the first server. The second server can receive and manipulate the data for presentation to the user in accordance with user-specified parameters.

The data presentation system further includes a software process, e.g., program, in communication with the second server. The software process can be implemented on a wireless device, and can enable the user to specify the parameters for presentation of the data. The parameters can include type of data, format of the data, points of interest, event notification, method of data delivery, and frequency of delivery.

The present invention also provides, in an embodiment, a method of providing an online lottery game, which includes allowing a user to choose a game and lottery numbers to play. The user may also be permitted to define a set of parameters for which the chosen numbers and game result data are to be presented. The game result may then be obtained by searching at least one data source site for game result data.

The game result data may then be manipulated in accordance with the set of parameters, and presented to the user. The user can be provided with an interface that allows the user to interact with one or more lottery games. The interface can be utilized by the user to define the set of parameters for which lottery data can be presented.

The present invention also provides a system in which an advertising platform can be created around the distribution and presentation of the mined data. An interface can present advertisements along with the data selected by the user for presentation. The advertisements can be presented in multiple formats including video, audio, slide show, pop-up box, and media player application.

The present invention further provides a method for the collection and presentation of mined data, such as those related to lottery results, sports, finance, entertainment, and other fields in an interactive manner to a recipient.

### BRIEF DESCRIPTION OF DRAWINGS

FIG. 1 illustrates a system for data mining and interactive presentation of same in accordance with one embodiment of the present invention.

FIG. 2 illustrates internal components of a server for use in connection with the present invention.

FIG. 3 depicts a listing of potential domain names for use in connection with the present invention.

FIG. 4 illustrates a pixmap having multiple hotspots for use in connection with the present invention.

FIG. 5 illustrates components of a system for data mining and interactive presentation of same in accordance with one embodiment of the present invention.

### DESCRIPTION OF SPECIFIC EMBODIMENTS

In view of the limitations now present in the prior art, the present invention provides a new system and method for data mining and for presenting such data fast and accurately in an interactive manner for subsequent use by a recipient.

Data mining, also known as Knowledge-Discovery in Databases (KDD), is the process of automatically searching large volumes of data for patterns. Although it is usually used in relation to analysis of data, data mining, like artificial intelligence, is an umbrella term and can be used with varied meaning in a wide range of contexts. It can oftentimes be associated with a business, or other organizational need to identify trends.

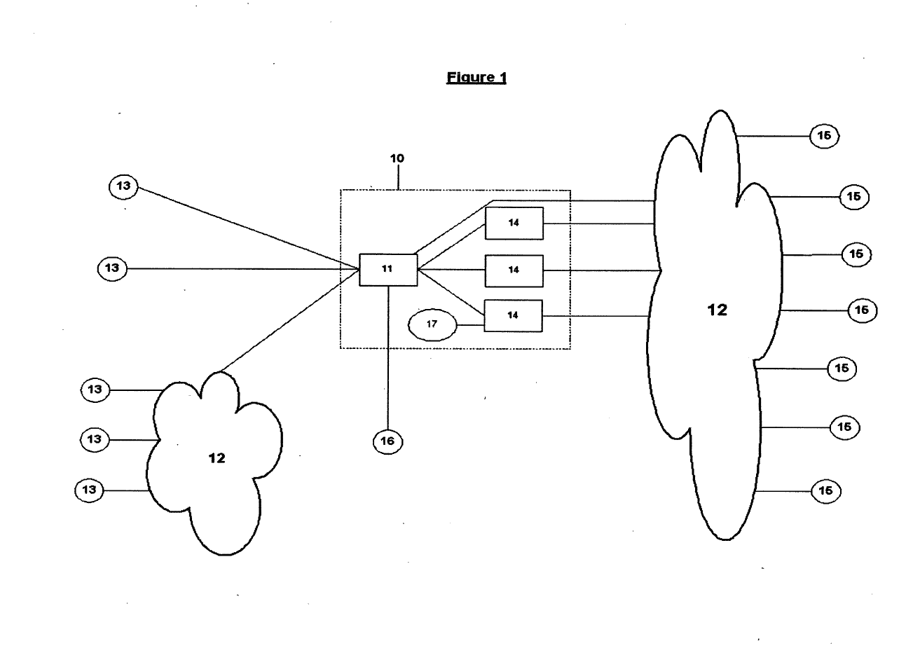

Looking now at FIG. 1, the present invention provides a system 10 for mining data and for subsequently presenting such data to a recipient in an interactive manner. System 10, in one embodiment, includes a first data processor for updating data, such as server 11, in communication with a telecommunications network 12, such as the Internet, LAN, MAN, WAN, wireless network, telephone system, cable system or similar data transmission systems, for collection of data from various data source sites 13, e.g., websites, databases. Communication between the server 11 and the network 12 may be accomplished through wired lines or wirelessly.

The system 10 may also include one or more secondary data processors, such as Web servers 14 that can, for instance, act as a lottery server, a sports server etc, in communication with server 11. A processor 17 may be external to Web server 14 or can be an internal component of Web server 14. Processor 17 can receive one or more parameters pertaining to data, and store the parameters in a database for later manipulation by Web server 14. A Web server 14, in an embodiment, may be a dedicated server for information from a specific area or sector (e.g., lottery, sports, finance, entertainment) or may be designed to accommodate data or information from multiple areas or sectors. A Web server 14 can be a computer, or a computer program that is responsible for accepting HTTP requests from clients, e.g., Web browsers, and serving them Web pages, which can be HTML documents having linked objects, such as images.

Although Web servers 14 can vary in configuration, they can share some basic common features. For example, each Web server can operate by accepting HTTP requests from a network 12, and can provide an HTTP response to the requester. The HTTP response typically includes an HTML document, but can also be a raw text file, an image, or some other type of document. If an error condition or failure is encountered during a client request, or while trying to serve the request, a Web server 14 can send an error response that may include some custom HTML or text messages to better explain the problem.

Web servers 14, in one embodiment, can be configured to log detailed information about client requests and server responses. These log files can then be analyzed to collect statistics, metrics, and establish performance benchmarks. Web servers 14 can also be implemented as virtual hosts, so as to serve, for instance, many Web sites using a single IP address.

Web server 14, can be implemented as a finite state machine server, multi-threaded server, process-based server, or a mix of all three. Finite state machine servers tend to maximize scalability, and offer fast service for static content. Process-based servers use multiple processes (rather than multiple threads within a single process), and offer higher reliability and security. However, many web servers may be multithreaded in order to efficiently serve dynamic content. This means that inside each server process, there can be two or more threads, each one able to execute its own task independently from the others.

For example, when a user visits a web site, a web server 14 can use a thread to serve the page to that user. If another user visits the site while the previous user is still being served, the web server can serve the second visitor by using a different thread. Thus, the second user does not have to wait for the first visitor to be served. This can be a useful implementation, because not all users may have the same speed Internet connection. A slow user should not delay all other visitors from downloading a web page.

Data collected from a data source site 13 may need to be validated, in order to verify that the data has been updated. Accordingly, in one embodiment, data collected from the data source site 13 may be sent by server 11 to Web server 14 for validation. If the data is valid, Web server 14 may send a notification to server 11 indicating that the data is valid and a data report may subsequently be generated by server 11. The data report, in an embodiment, may be in multiple formats, for instance XML, HTML, and text. If the data is not valid, Web server 14 may send a failure notification to the server 11.

Web server 14, in one embodiment, may also be in communication with a client platform 15. A client platform 15 can be a server, laptop, cell telephone, or other communication devices, wired or wireless. One or more client platforms 15 can utilize, for instance, a web browser to display static and dynamic content pulled from various web servers 14. Static content originates from an existing file residing on a filesystem or data store, and dynamic content can be dynamically generated by some other program, script, or API called by the Web server 14. Serving static content can usually be much faster (from 2 to 100 times) than serving dynamic content, especially if the latter involves data pulled from a database. By using multiple Web servers 14 to distribute information to various client platforms 15, the flow of data to and from a particular Web server 14 can be distributed in such a manner so that any one Web server 14 can avoid being overloaded.

Web servers 14, in particular, can be overloaded due to many reasons including, too much web traffic (i.e. thousands or even millions of clients hitting the web site in a short interval of time), distributed denial of service attacks, and web servers partial unavailability resulting from maintenance or upgrade downtime, hardware or software failures, database failures, etc. In these cases, the remaining web servers 14 get too much traffic and become overloaded.

The symptoms of an overloaded Web server include, noticeably long delays between requests (from 1 second to a few hundreds of seconds), HTTP 500, 503 errors and sometimes a 404 error can be returned to clients; and TCP connections may be refused or reset before any content can be sent to clients. Techniques for avoiding overloading include, deploying Web cache techniques, using different URLs to serve static and dynamic content, using many Web servers (programs) per computer, each one bound to its own network card and IP address, or using multiple Web servers (computers) that can be grouped together so that they act as one big Web server (load balancer).

The system 10, in one embodiment, may be designed to also include proprietary software that can be housed in server 11 or Web server 14, and capable of collecting and presenting lottery data from lotteries played all over the world in a near instantaneous manner with comprehensive accuracy. Such data can be presented on an hour by hour, day by day, week by week, month by month, year by year basis, or any defined time period desired. Such an approach can similarly be adapted to collect and present data in areas other than lottery, such as sports, entertainment, finance, and other areas where data and information can be collected. The system 10 may also be designed to allow consumers or users to visit a single online destination or interface, and to have access to data collected by the system 10 in a near instantaneous and accurate manner. The user may select the data to be presented, and the method of presentation. Specifically, the user can select a set of parameters that can include type of data, format of the data, points of interest, event notification, method of data delivery, and frequency of delivery.

To accomplish some of these tasks, server 11 may be provided with a Web crawler program that targets specific websites and databases to collect necessary data or information, e.g., lottery data, sports data, entertainment data, finance data, or data from other areas automatically. In one embodiment, the crawler program can be designed to process data in any format, including HTML, XML, text, images, etc.

A Web crawler (also known as a Web spider or Web robot) is a program that browses the World Wide Web in a methodical, automated manner. Web crawlers are mainly used to create a copy of all the visited pages for later processing by a search engine, which will index the downloaded pages to provide fast searches. Crawlers can also be used for automating maintenance tasks on a web site, such as checking links or validating HTML code. Also, as in an embodiment of the present invention, crawlers can be used to target and gather specific types of information from Web pages, such as lottery data, sports data, etc.

A Web crawler is one type of bot, or software agent. In general, it starts with a list of URLs to visit. As it visits these URLs, it identifies all the hyperlinks in the page and adds them to the list of URLs to visit, recursively browsing the Web according to a set of predefined policies.

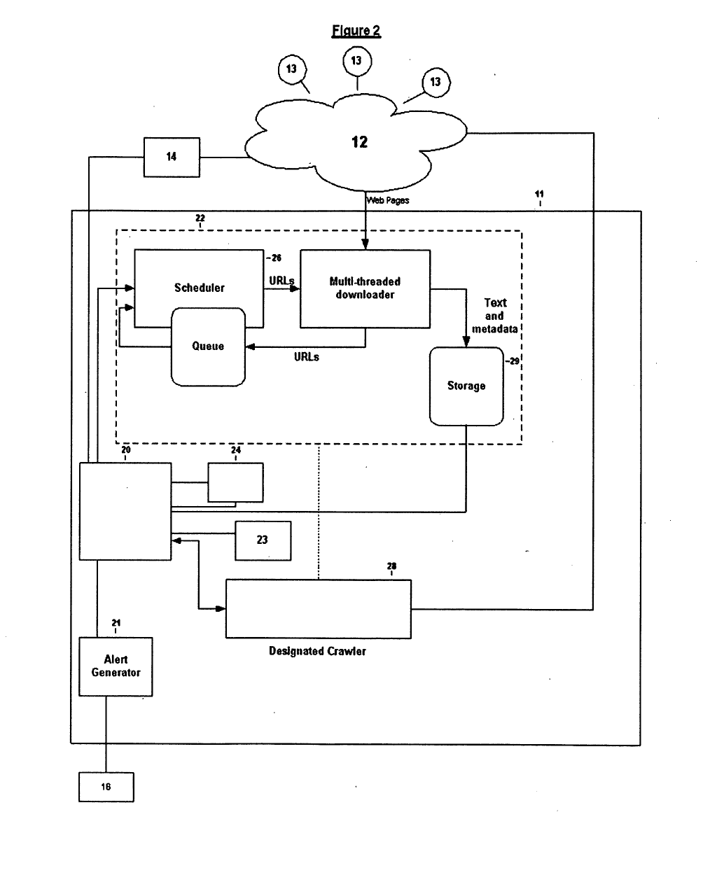

Looking now at FIG. 2, the server 11 may also be provided with a main update program 20 designed to, in an embodiment, run substantially continuously on server 11 monitoring the status of data files 24, 29 and data source sites 13. In one embodiment, the main update program 20 can read certain initialization and adaptation files 24 when it is launched. For example, it may be permitted to read a file containing, for instance, a listing of all the lottery games, their drawing days, drawing time, if the game has a jackpot, etc.

In addition, the update program 20 can be designed to signal one or more crawler programs 22 to crawl targeted data source sites 13 after a predetermined amount of time subsequent to a lottery drawing. To the extent that the data 29 is not updated for that targeted data source site 13, a crawler 22 can be prompted to scan at designated intervals. In an embodiment, the update program 20 can signal and prompt a crawler 22 to revisit one or more data source sites 13 via a scheduler module 26. The update program 20 should schedule revisits by a crawler 22 to data source sites 13 frequently enough to minimize the fraction of time the data 24, 29 remains outdated. Web crawling can be modeled and thought of as a multiple-queue, single-server polling system, in which the web crawler 22 acts as the server and the data source sites 13 are the queues. The update program 20 can schedule crawler 22 revisits in a variety of implementations. For example, scheduling the crawler 22 to revisit all the data source sites 13 with the same frequency, regardless of their rates of change; or scheduling the crawler 22 to revisit more often the data source sites 13 that change more frequently.

The update program 20 may also be designed, in an embodiment, to access the URL addresses of the targeted data source sites 13, i.e., websites, from one or more adaptation files 24. For instance, to get updated lottery results, the update program 20 may access the URLs of the targeted data source sites 13 from an adaptation file 24, and can assign the URLs to one or more crawlers 22 dynamically or statically. Dynamic assignment allows the update program 20 to, for instance, dynamically balance the load of each crawler 22. Static assignment can also be implemented by assigning URLs to one or more crawlers 22 in accordance with a predefined policy. Although not necessary, the use of parallel crawlers 22 maximizes the download rate, and helps to avoid overloading.

One or more crawlers 22, may be permitted to utilize the assigned URLs to target the correct data source sites 13. As soon as the targeted data source site 13 is identified by the corresponding URL, the update program 20 can launch a crawler 22 to parse the content of that targeted source site. The crawler 22 can then extract and store the data or results in a data store 29. The update program 20 can then retrieve and analyze the new data from the data store 29, and send the data to one or more web servers 14.

In an embodiment, each game result (e.g., lotto game result) or group of data can be designed to be associated with a particular designated crawler 28, to handle each special case of each game or group of data. The designated crawler 28 can also be designed or tailored to pin-point the exact location of the data and extract the results. In particular, the designated crawler 28 can inform the update program 20 if the data has been updated, and if so, the update program 20 can send the data to the one or more web servers 14.

The update program 20 may further be designed to read an adaptation file 24 to identify IP addresses of the web servers 14, which in one embodiment can be remotely located. As soon as the server 11 successfully generates a new update, it may send the update to several of the web servers 14. Each web server 14 may then process the data it receives and validate the results. If the results are valid, each web server 14 can update its database, and then send a response back to server 11 to indicate that the results have been updated successfully. Server 11 may then generate, for instance, a data report in a variety of formats including HTML, XML and text.

The server 11, once it receives the successful validation response from the web server 14, can also mark its own database 23 to reflect the game update as complete. The server 11 can then stop scanning for an update for that particular game on the data source sites 13 until the next cycle. If the results, however, are not valid, the web server 14 can send server 11 a failure response. The server 11 can then continue scanning for the update of the game. It should be noted that one game can have more than ten targeted data source sites 13 with relevant information, and each of those sites 13 can require processing by crawlers 22, 28 and analysis by the update program 20.

The server 11, in another embodiment, may be designed to periodically send updated results to web server 14. To that end, one or more client platforms 15 can retrieve the latest update from the web servers 14 by, for instance, file transfer protocol (FTP). The server 11 can also send (e.g., email, FTP, SMS, MMS) the latest update to client platforms 15 according to a schedule required by a client. For example, some clients may require that the updated data be sent every 5 minutes or less, some may require data once an hour, whereas some may require data once a day. Normally an XML or text format may be sent to a client FTP server. In addition, the system 10 permits the clients to modify their platform 15 in order to process the data received and convert the data into their own format, such as web page, without affecting the data being forwarded to the client platform 15.

FTP is a commonly used protocol for exchanging files over any network that supports the TCP/IP protocol (such as the Internet or an Intranet). There are two computers involved in an FTP transfer: a server and a client. The FTP server, running FTP server software, listens on the network for connection requests from other computers. The client computer, running FTP client software, initiates a connection to the server. Once connected, the client can do a number of file manipulation operations, such as uploading files to the server, download files from the server, rename or delete files on the server and so on. Virtually every computer platform supports the FTP protocol. This allows any computer connected to a TCP/IP based network to manipulate files on another computer on that network regardless of which operating systems are involved (if the computers permit FTP access).

The server 11, as noted above, may be connected to a telecommunications network 12 using a regular Internet connection, for example, cable connection, or dial-up connection to access targeted data source sites 13 (websites) and collect lottery data. In addition, the update program 20 of server 11 may be permitted to rescan the targeted data source sites 13 several times a day to recheck the results and correct any possible errors automatically. To that end, the server 11 may be provided with a connection alert system 21 to periodically validate the integrity of the connection. If the connection is valid, a timestamp indicating the time of validation can be saved on web server 14 for future comparison and maintenance purposes.

In an embodiment, the system 10 may be provided with a “connection failure” alert 21 if communication between the server 11 and web server 14 does not occur within a predetermined period of time. For instance, if the last connection time has been more than, for example, 10 minutes, when communication is to occur every 10 minutes, an alarm 21 may be triggered and a message may be sent to an adapted communications device 16, such as a cell phone or other device, independent of system 10 but capable of being monitored by the operator of system 10, to inform the operator that the connection has failed for 10 minutes, so that the failure can be corrected.

In another embodiment, the update program 20 can be designed to detect a “update failure” alert 21. For instance, a data source site 13 may fail to update within a predetermined period of time, the server 11 may trigger an alarm 21 and send an alert message to an adapted communications device 16. In particular, when a failure occurs, a switch to a back up connection may be done automatically to ensure data collection and distribution is not affected by a loss of the primary connection. Additional alerts 21 for failure in data collection or distribution can also be provided. For example, if game results are not updated for a certain predetermined period of time, the server 11 may send an instant message to a cell phone or other device of choice that can be monitored by the operator. In these cases, a manual search for the results and data of the failed feeds can be implemented and the system updated manually.

A “data source website change” alert 21 may also be provided. For example, if a data source site 13 changes, a crawler 22, 28 may not be able to extract data from this data source site 13. In this case, the server 11 may trigger and sound an alarm 21 and send a text message to an adapted communications device 16. An operator can then manually update the data and make corresponding changes to the adaptation files 24, or crawler 22, 28 on the server 11, so that changes may be recognized the next time around.

The web servers 14, in an embodiment, may be designed to process the data sent by server 11. For example, the web server 14 may process the data and check for a variety of possible errors, including, for instance, the range of the numbers, whether there is any duplicate numbers in the lotto type games, whether the bonus number is the same as one of the regular numbers, etc. If any errors are found, the web server 14 can reject the update and inform the server 11. The web server 14 may also check whether the winning numbers are the same as a previous drawing, and if so, it can reject the update.

The web server 14 may, in another embodiment, be designed to use multiple HTML formats available for client web sites to allow for customization and appealing presentation of the lottery data and services. Each data format may include a number of different color combinations (e.g., up to 20 or more), which may be achieved by changing the Cascading Style Sheets (CSS) file for each format. CSS is a stylesheet language used to describe the presentation of a document written in a markup language. Its most common application is to style web pages written in HTML and XHTML, but the language can be applied to any kind of XML document, including SVG and XUL. CSS can be used by both the authors and readers of web pages to define colors, fonts, layout, and other aspects of document presentation.

The system 10 may also include features that make the initial setup simple and easy for clients wishing to display data via a website on their client platform 15. In an embodiment, the client platform 15 only needs a one-time setup that may include the installation of tools that can be utilized to manipulate the presented data. In addition, the clients only need to maintain a minimal number of files. If there are any game changes, the process can be transparent and the clients remain unaffected, since the changes and modifications can be accomplished within system 10, and particularly within the web servers 14.

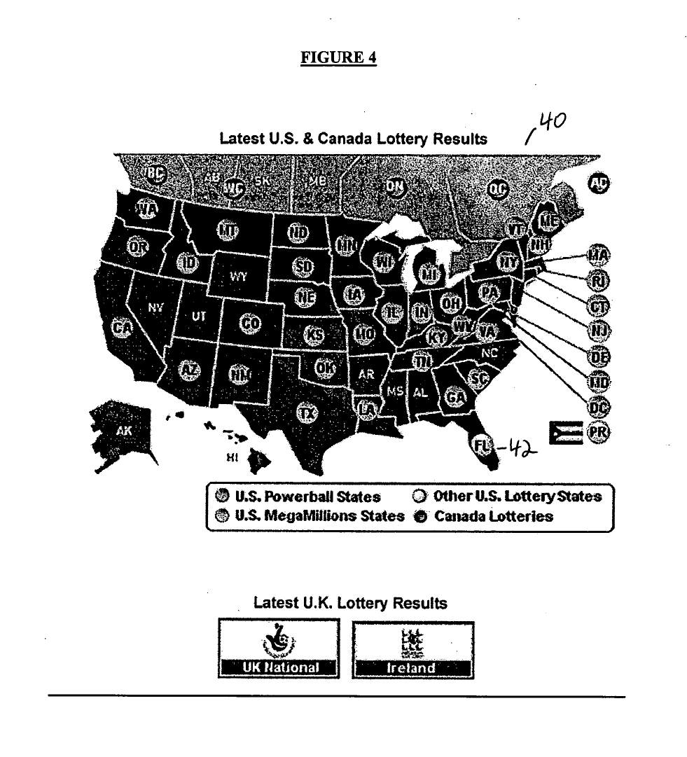

As illustrated in FIG. 4, the system 10 may further include interactive graphic maps 40 of states or countries that have, for instance, lottery results to display. This allows the client to, for instance, simply use a cursor to point and click on a hotspot location 42 within a pixmap (i.e., colored raster image) file 40 to link to the particular state or international results. If new states or countries are added subsequently, the pixmap 40 can be updated or modified by system 10 automatically, and particularly within the web servers 14, thereby leaving clients unaffected by the modifications.

In accordance with one embodiment of the present invention, system 10 may be designed to provide a presentation format that allows for many of the data items and functions to be interactive and to be displayed on a single webpage. In one approach, content and data items, which may be derived from a plurality of data source sites 13 can be aggregated and displayed on a single web page on Web server 14. The single web page may contain interactive functions that a user can utilize to manipulate the data. As such, the users may be permitted to view the data and features at one location and interact with such data and features in a convenient manner.

Some of these unique features and functions that can be displayed on a single web page may include, for example, all the lottery results, numbers archive, smart pick, jackpots, and quick picks. In addition, the users may also view these features and data by selecting any one of the displayed items, such as, state lottery results. In particular, when the users select, for instance, by clicking on recent results, numbers archive or other features, the selected items can be displayed and the web page URL does not change. To that end the system 10 can be designed to display different content within a single web page.

This approach may be achieved, in one embodiment, by using HTTP cookies. An HTTP cookie is a packet of information sent by a server to a Web browser, and then sent back by the browser each time it accesses that server. HTTP cookies can be used for user authentication, user tracking, and maintaining user-specific information such as site preferences and electronic shopping carts.

Cookies can be used for realizing functionalities that may be specific to a user. In other words, cookies allow for personalization based on user preferences. Personalization can include presentation and functionality. For example, the Wikipedia Web site allows authenticated users to decide the “skin” of pages; the Google search engine allows users (even non-registered ones) to decide how many hits per page they want to see.

Technically, cookies are arbitrary pieces of data chosen by a Web server and sent to a browser. The browser returns them unchanged to the server, introducing a state (memory of previous events) into otherwise stateless HTTP transactions. Without cookies, each retrieval of a Web page or component of a Web page is an isolated event, mostly unrelated to all other views of the pages of the same site. By returning a cookie to a web server, the browser provides the server a means of connecting the current page view with prior page views. Other than being set by a web server, cookies can also be set by a script in a language such as JavaScript, if supported and enabled by the Web browser.

JavaScript is a prototype-based scripting language. One major use of web-based JavaScript is to write functions that are embedded in, or included from HTML pages and interact with the Document Object Model (DOM) of the Web page to perform tasks not possible in HTML alone. Some common examples of this usage include: 1. opening or popping up a new window; 2. validating Web form input values before they are submitted to the server; and 3. changing images as the mouse cursor moves over them.

JavaScript can also be used in web pages to make calls to Web and Web-service servers after a particular Web page has loaded, depending upon user actions. These calls can obtain new information, which further JavaScript can merge with the existing DOM of a particular Web page so that it is displayed.

In one embodiment, when a user operating at a client platform 15 utilizes a browser to send a request to Web server 14, such as for recent lottery results, the Web server 14 can respond by sending the requested Web page along with a cookie. The browser then stores the cookie on the client platform 15. The next time the browser requests another Web page, it will also send the cookie back with the request. Subsequently, when a request is received by web server 14, the web server 14 can access the cookie, which may contain user preferences, and respond back in a way which allows the data and content to be displayed interactively, as noted above. The new content can actually be viewed by refreshing the same web page. This can be a beneficial way of presenting lottery data on a client Web site. An example of this approach can be illustrated as follows:

1. A user operating at a client platform 15 can visit a particular lottery results page. A JavaScript may be downloaded automatically in the background from the browser on the client platform 15 to access a cookie. Alternatively, a CGI script from a Web server 14 may also plant or access a cookie.

2. The user can select a particular lottery result by clicking on a link, such as Smart Pick of a Powerball game.

3. The requested information, for example, the game identifier “Powerball”, and the request type “Smart Pick” can be stored in a cookie and saved onto the computer.

4. The lottery results Web page on the client platform 15 can then be refreshed. The reload of the page can trigger a JavaScript function call that can identify which application (to call to retrieve data) on web server 14 corresponds to the link selections made by the user.

5. The application (e.g., SmartPick) residing on Web server 14 may then retrieve the request information (game identifier, request type) saved in the cookie.

6. The application (SmartPick) can then process the request by extracting relevant data from a database on Web server 14, and rewriting the HTML document with JavaScript. The resulting new Web page content can then be sent and displayed on the same lottery results page on client platform 15.

In a second approach, an inline frame that has syntax as <iframe> . . . </iframe>, can be utilized to present new content, or to contain Web pages on the client platform 15, which are normally hosted on the Web server 14. An inline frame is a structure element that can be used inside a normal HTML <body>, to embed another HTML document. In other words, the <iframe>element allows an HTML document to hold or “frame” another HTML document. Similar document elements include the now more common <object>element, which produces the same effect in all modern browsers.

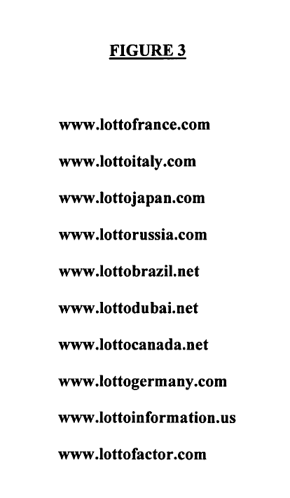

By providing a system 10 as set forth above, current and previous data, such as lottery results from lotteries played in many countries and states and locations around the world, may be collected and customized for subsequent display of such results. Moreover, an online data reporting service may be provided by country specific segments. In particular, by using a network of country specific domain names, for instance, country specific lottery domain names used to drive search engine traffic, branding, and advertising revenue, such as those illustrated in FIG. 3, an online data reporting service may be created specific to a particular area or sector.

The system 10 also provides a way for users to select one or more parameters that are then utilized by the system to create a custom presentation format of the data in a manner that the users prefer. In particular, the system 10 may allow users to interact with the mined data via, for example, wireless devices and web based environments. For instance, the users can select specific parameters and data that is relevant to them, such as lottery results, sports scores, weather, financial information, entertainment information, etc. Using a wireless or web based interface, consumers can then select additional parameters and specific points of interest around their selected information or data that interests them. This could include (i) asking to be notified how much they have gained or lost on a particular stock at a given time, (ii) how many winning lottery numbers they may have matched for a specific draw, along with the actual prize money they might have won, (iii) when a particular movie has grossed a certain amount of revenue at a box office, (iv) how much money they may have won or lost on a specific sports bet, (v) how many degrees the temperature in a specific location has changed from a set point of time, and many other data points.

The system 10 also allows users to select, in advance, parameters and data in which they may be interested and specific information relating to that data that they may want delivered to them via their wireless devices and or web based environment via email or online members area. The parameters may include type of data, format of the data, points of interest, event notification, method of data delivery, and frequency of delivery.

Unlike previous services that may simply display static data, such as stock quotes, lottery numbers, or sports scores, the system 10 allows users to interact with the data in a more detailed fashion. Results of users requests can be displayed, in an embodiment, via wireless transmission to cell phones, PDA's, and other wireless devices as well as in an online environment via the Internet.

For example consumers could do the following:

1) go to a web site or wireless web portal and select a specific lottery game or games from around the world.

2) they could then select specific information regarding the game that they wanted to be notified of, such as when the jackpot reaches a certain level; consumers can also request a reminder to be sent before the draw date, and also have the ability to enter in the numbers they want to play for a specific game.

3) they would then be notified automatically via the wireless application (or by online access) letting them know when the above conditions are met; in the case of the lottery draws they would also be told what numbers they matched for a specific lottery draw, and how much they won from that draw.

4) If a customer wants to know when Powerball hits $30 million, and the customer wants to be reminded 24 hours before each draw, and the customer will be playing the numbers 5-6-11-19-23-25, then the customer can receive 3 notifications on his wireless device:
they would be notified when the jackpot climbed above $30 million,
they would be notified 24 hours in advance of the drawing,
and they would be notified of the winning numbers, including telling them how many numbers they matched and how much money they won.

This type of system can also be utilized for delivering sports data, entertainment data, and other forms of data. For example, consumers may set up wireless notifications to let them know how many games they bet on covering the point spreads, how much money they won or lost on a given set of bets, etc. For example, a customer might utilize the system to bet $200 on each of the following football games:
New England−7 vs Seattle
Miami+3 vs NY Giants; and
a $300 bet on a baseball game Boston vs New York, picking Boston to win.

The system 10 could be set up to notify a customer of the scores of each game, and also how much was won or lost in total based on the results of those games.

Furthermore, system 10 may further provide a way for online media companies, portals, website developers, radio stations, newspapers, gaming sites, and others to provide customizable data reporting solutions to their audiences and customers. In addition, cellular telephone companies, SMS messaging companies, and others in related fields may use system 10 to pass on to their audiences and customers data results that can be customized according to customer/end user preferences as needed.

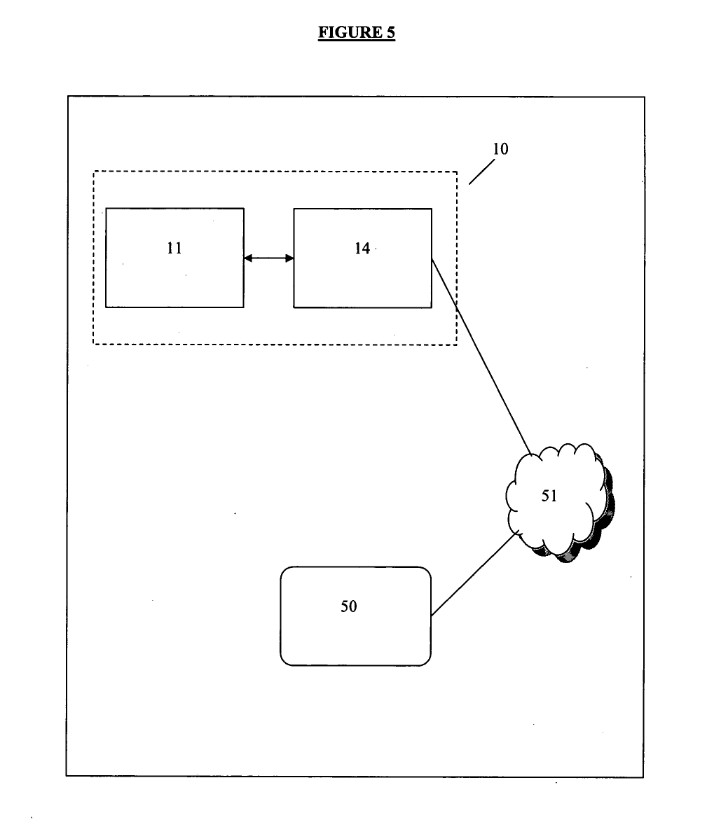

Looking now at FIG. 5, in another embodiment, the interactive features discussed above can also be implemented into a program, such as firmware or other software process 50 that can be downloaded or preloaded onto mobile phones and other wireless devices. The software process 50 can be in communication with one or more web servers 14 via a wireless telecommunication network 51. The software process 50 can include a user-interface, such as a web browser, through which a user can select parameters, including the types and format of data to be presented. The software process 50 may also allow user selections to be made for additional parameters including notifications, reminders, data delivery times, delivery method, and storage of user defined parameters regarding the presentation of data. The software process 50 may also provide analysis tools, such as odds calculators and statistical analysis. In fact, the software process 50 can include a subset of the functionality of web server 14. In operation, software process 50 can be utilized by a user to interact with web server 14, thereby establishing how, when, what, and in which format data of interest to the user can be presented. This adaptation can facilitate wireless equipment providers and consumers, by enabling wireless devices to come preloaded with software that then interacts with the wireless data, e.g., lotteries, sports, financial, entertainment.

System 10 can also serve as a platform where companies or entities can acquire ancillary services and products, such as, leasing/buying advertising space on the website, or purchasing a specific domain name, that may come bundled with data reporting services provided in connection with the present invention. In this manner, an advertising platform can be woven into the data reporting services to allow advertisers to have unique and focused advertising options to reach the audience accessing the data.

In addition, a specific bundle of data tools may be provided that can be used by consumers, such as, odds calculators, jackpot monitoring, frequency analysis, wheeling systems, zodiac based numerology systems, and other components. Other examples include, but are not limited to, statistical analysis and presentation of bundled tools to allow consumers or visitors to look at sports statistics, financial data, or data specific to any given field that can be updated in real time and then distributed to others in informative and interactive ways.

System 10 may also be designed to permit customization by consumers so that data can be automatically delivered to individuals through email, SMS text messaging, Multimedia Messaging Service (MMS), or other services. SMS is a service available on most digital mobile phones that permits the sending of text messages between mobile phones, other handheld devices, and even landline telephones. MMS is a technology for transmitting not only text messages, but also various kinds of multimedia content (e.g. images, audio, and/or video clips) over wireless telecommunications networks.

In an embodiment, system 10 can be utilized by individuals to play an online lottery via a website, or wireless device such as a cell phone. Alternatively, system 10 can be utilized by existing lottery game operators (State lottery commissions), to enable online or wireless play of their lotteries. In either case, participants can access system 10 through an online interface, or wireless device in order to purchase lottery tickets and play the lottery. The players who want to participate can be notified in advance via SMS, MMS, or email lottery draw times. Participants can then choose their numbers using their wireless device or web browser interface. A confirmation email or SMS or MMS can then be sent to each player confirming their enrollment in the draw. A lottery draw can subsequently take place, and all participants can be notified of the winning numbers and prize amount via email, SMS, or MMS.

In one embodiment, the jackpot for this lottery can be self-funded through the cost of the tickets, or through the purchase of an insurance policy. Participants can pay for access to the game via a prepaid account, a monthly recurring charge, an annual fee, or by paying online or wirelessly for each ticket via messaging fees, or other approved payment methods. Server 11 or Web server 14 can be used to store player and game information, for instance, all of the lottery tickets played, a listing of the time of the play, the numbers played, and the participants actual identification numbers. The technology can be licensed to sportsbooks and online gaming sites for example, as well as to mobile companies in countries that allow gaming. The technology can also be licensed to state and government sanctioned lotteries.

In another embodiment, advertisements can also be launched and managed from an interface, as the user plays a lottery or interacts with the data. The interface can include a web browser that may be operating on a server, laptop, or wireless device. For instance, the advertisements can be displayed when a user clicks on links to interact with the lottery data, or to define a set of parameters. The advertisements can be presented in multiple formats including video, audio, slide show, pop-up box, and as a media player application. For example, and with reference to FIG. 4, when a user clicks on a hotspot 42 that represents the state of Florida on an interactive pixmap 40 of North America, a small media player can be launched to present a specific advertising message targeting the audience that would be clicking on the Florida lottery.

It is intended that any of the data collection and presentation methods described herein may also be used to collect and present other data not specific to lottery results. For example, this collection and presentation methods could be used to collect and display data in the financial arena such as stocks, bonds, indices, currency values, and other areas such as real estates, commodities, fuel prices, and any other data that can be collected and displayed to an audience.

While the invention has been described in connection with the specific embodiments thereof, it will be understood that it is capable of further modification. Furthermore, this application is intended to cover any variations, uses, or adaptations of the invention, including such departures from the present disclosure as come within known or customary practice in the art to which the invention pertains.

We claim:

1. A data presentation system comprising:
a first server for obtaining data of interest to a user from at least one data source site,
a processor designed to receive one or more user specified parameters in connection with the data, and
a second server in communication with the first server, to receive and manipulate the data from the first server for presentation to the user in accordance with the parameters specified by the user.

2. A system of claim 1, wherein the data source sites include one of web sites, databases, or a combination thereof.

3. A system of claim 1, wherein the first server includes an update program that continuously monitors the status of data files and data source sites for new data.

4. A system of claim 3, wherein the update program can signal a web crawler program to retrieve updated data from the data source sites at predetermined time intervals.

5. A system of claim 1, wherein the data includes one of lottery, sports, entertainment, financial data, or a combination thereof.

6. A system of claim 1, wherein the processor is operating on the second server.

7. A system of claim 1, wherein the parameters include one of, type of data, format of the data, points of interest, event notification, method of data delivery, frequency of delivery or a combination thereof.

8. A system of claim 1, wherein the second server is a web server.

9. A system of claim 1, wherein the second server is designed to present manipulated data via one of a website, email, SMS, MMS, online members area, or a combination thereof.

10. A system of claim 1, wherein the first server sends data updates directly to client platforms via email, FTP, SMS, MMS.

11. A system of claim 1, wherein the first server includes an alert system that identifies and provides notification of system failures.

12. A system of claim 11, wherein an alert condition includes a SMS notification designed to be sent to an external communication device.

13. A method of presenting data, the method comprising:
allowing a user to define a set of parameters for which data is to be presented to the user,
manipulating the data in accordance with the parameters, and
presenting the manipulated data to the user.

14. A method of claim 13, wherein the step of allowing includes providing a user with a user-interface to define the set of parameters.

15. A method of claim 13, wherein, in the step of allowing, the set of parameters include a type of data, format of the data, points of interest, event notification, method of data delivery, and frequency of data delivery.

16. A method of claim 13, wherein the step of manipulating includes obtaining data from at least one data source site.

17. A method of claim 13, wherein the step of manipulating, the data includes one of lottery, sports entertainment, financial data, or a combination thereof.

18. A method of claim 13, wherein the step of manipulating includes obtaining the data at a predefined time period.

19. A method of claim 13, wherein the step of presenting includes displaying the manipulated data at a predefined time period.

20. A method of claim 13, wherein the step of presenting includes distributing the data via a telecommunication network to one or more client platforms associated with the user.

21. A method of claim 13, wherein the step of presenting includes presenting the manipulated data via one of a website, email, SMS, MMS, online members area, or a combination thereof.

22. A method of claim 13, wherein the step of presenting includes allowing users to access the manipulated data via web browser or wireless device.

23. A method of claim 13, wherein the step of presenting includes presenting at least one advertisement along with the data selected by the user.

24. A data presentation system comprising:
a first server for obtaining data of interest to a user from one or more data source sites,
a second server, in communication with the first server, to receive and manipulate the data from the first server for presentation to the user in accordance with parameters specified by the user,
a software process remotely situated from the first and second server at a user site, designed to be in communication with the second server, so as to enable the user to specify from the remote location parameters for presenting the data.

25. A system of claim 24, wherein the data source sites are web sites.

26. A system of claim 24, wherein the data includes lottery, sports, entertainment, and financial data.

27. A system of claim 24, wherein the second server is a web server.

28. A system of claim 24, wherein the second server is designed to present the manipulated data via one of a website, email, SMS, MMS, online members area, or a combination thereof.

29. A system of claim 24, wherein the parameters include types of data and format of data to be presented, points of interest, event notification, reminders, data delivery times, data delivery method, frequency of data delivery, and storage of parameters.

30. A system of claim 24, wherein the software process includes a user-interface through which the user can specify the parameters for presentation of the data.

31. A system of claim 24, wherein the software process is executable on a wireless device.

32. A system of claim 24, wherein the software process is downloadable to a wireless device via a telecommunication network.

33. A system of claim 24, wherein the software process is provided on a wireless device.

34. A method of providing an online game, the method comprising:
allowing a user to choose a game and numbers to play,
permitting the user to define a set of parameters for which the chosen numbers and game result data are to be presented,
obtaining the game result by searching at least one data source site for game result data,
manipulating the game result data in accordance with the set of parameters,
presenting the manipulated game result data to the user.

35. A method of claim 34, wherein the step of allowing includes choosing a lottery.

36. A method of claim 34, wherein the step of allowing includes providing an interface that allows the user to interact with a lottery game.

37. A method of claim 36, wherein the step of allowing includes providing the interface on a computer or wireless device.

38. A method of claim 36, wherein step of allowing includes providing the interface to the user as a website.

39. A method of claim 34, wherein, in the step of permitting, the set of parameters include a type of data, format of the data, points of interest, event notification, method of data delivery, and frequency of data delivery.

40. A method of claim 34, wherein the step of permitting, the data includes lottery, sports, entertainment, and financial data.

41. A method of claim 34, wherein the step of obtaining further includes the step of waiting for the game result to occur.

42. A method of claim 34, wherein the step of obtaining, the data source site is a website.

43. A method of claim 34, wherein the step of presenting includes presenting the manipulated data via one of a website, email, SMS, MMS, online members area, or a combination thereof.

44. A method of claim 34, wherein the step of presenting includes presenting at least one advertisement along with the data selected by the user.
